(19) United States
(12) Patent Application Publication
(10) Pub. No.: US 2015/0216760 A1
(43) Pub. Date: Aug. 6, 2015

(54) Multi-Port Connection and Multi-Port Multiple Outlet Manifold

(71) Applicants: Joseph Thomas Adams, Howell, MI (US); Paul Andrew Zwirkoski, Pinckney, MI (US)

(72) Inventors: Joseph Thomas Adams, Howell, MI (US); Paul Andrew Zwirkoski, Pinckney, MI (US)

(21) Appl. No.: 14/614,229

(22) Filed: Feb. 4, 2015

Related U.S. Application Data
(60) Provisional application No. 61/965,688, filed on Feb. 4, 2014.

(51) Int. Cl. A61H 9/00; F16L 37/00; A61H 1/00

(52) U.S. Cl. CPC A61H 9/0078; A61H 1/008; F16L 37/008; A61H 2201/0103; A61H 2201/1409; A61H 2201/5002

(57) ABSTRACT

A manifold for use with an intermittent compression device garment, said manifold comprising: a plurality of outlet ports, where each of said outlet ports is fluidically connected to a chamber within a fluid fillable garments; and an inlet port fluidically connected to a fluid pump.

### RELATED APPLICATIONS

The present application claims the benefit of provisional U.S. patent application Ser. No. 61/965,688, filed Feb. 4, 2014, and entitled, Multi-Port Connection and Multi-Port Multiple Outlet Manifold.

### FIELD

The present invention relates generally to multi-port connection and multi-port multiple outlet manifolds and methods for using the same. In particular, the present invention relates to improved multi-port connections, multi-port manifolds and for using the same.

### BACKGROUND

The present invention, as disclosed herein, provides improved multi-port connections, multi-port multiple outlet manifolds, and methods of transmission of various fluids through the connections and out of multiple outlets. The devices disclosed in the present invention may be used in a variety of applications, including pneumatic and/or hydraulic applications such as an intermittent pneumatic compression (IPC) pump systems.

Intermittent pneumatic compression is a therapeutic technique used in medical devices that include a fluid, air, oil, water, etc. pump and inflatable auxiliary sleeves, gloves or boots in a system designed to improve venous circulation or bodily fluids such as blood, lactic acid or proteins, in the limbs of patients who suffer edema or the risk of deep vein thrombosis (DVT), pulmonary embolism (PE) or have suffered a traumatic or surgical injury. As used herein “air pump” is inclusive of any fluid pump including heated fluids. As used herein “blood,” is inclusive of all bodily fluids such as blood, lymphatic fluids, or other tissue fluids.

In use, an inflatable jacket (sleeve, glove or boot) encloses the limb requiring treatment, and pressure lines are connected between the jacket and the fluid pump. When activated, the pump fills the fluid chambers of the jacket in order to pressurize the tissues in the limb, thereby forcing fluids, such as blood and lymph, out of the pressurized area. A short time later, the pressure is reduced, allowing blood flow back into the limb.

The primary functional aim of the device “is to squeeze blood from the underlying deep veins, which, assuming that the valves are competent, will be displaced proximally.” When the inflatable sleeves deflate, the veins will replenish with blood. The intermittent compressions of the sleeves will ensure the movement of venous blood.

Sequential compression devices (SCD) utilize sleeves with separated areas or pockets of inflation, which works to squeeze on the appendage in a “milking action.” The most distal areas will initially inflate, and the subsequent pockets will follow in the same manner.

Sequential calf compression and graduated compression stockings are currently the preferred prophylaxis in neurosurgery for the prevention of DVT and pulmonary embolism, sometimes in combination with low molecular weight heparins or unfractionated heparin.

Intraoperative SCD-therapy is recommended during prolonged laparoscopic surgery to counter altered venous blood return from the lower extremities and consequent cardiac depression caused by pneumoperitoneum (inflation of the abdomen with carbon dioxide).

IPC devices are prescribed as a treatment option for patients with Lymphedema when conservative treatments such as compression garments or massage have failed. Pumps are available with a wide variety of controls and other features for use with single chamber or multiple chamber garment designs.

There are three main types of lymphedema pumps available, namely:

Type I: Non-segmented single chamber nonprogrammable pumps,

Type II: Segmented multi-chamber nonprogrammable pumps, and

Type III: Segmented multi-chambered programmable pumps.

There are many competing pump designs in the intermittent compression pump and inflatable garment field. These pumps along with various body garments allow the pressurization of specific chambers or portions of the garment thereby applying controlled pressure gradients over specific timetables to various portions of the body. Many articles report incidents of improved health conditions for patients when IPC devices are used.

In the medical field, the devices are used to treat the conditions of lymphedema, edemas and venous stasis. In the sports industry, intermittent pneumatic compression devices are used with an without head or cold treatment to decrease muscle soreness, improve recovery time, and decrease the incidence of interstitial edema by forcing fluid from the tissue back into the venous system.

In both medical and sports industries, health care professionals and IPC users desire the capability to attach one or two garments to a patient at a time in order to treat one or more areas of a body simultaneously. For the IPC user to receive treatment through the use of two garments, the pump must fill and deflate multiple outlets of a multi-ported connection to various body garments with one or more pressure chambers.

For example, a user may want to simultaneous treat a left and right leg simultaneously with lower limb garments that may have ten chambers per garment. The pump needs to fill both garments multi-ported chambers simultaneously. This typically requires that a single compressor within the pump provide for filling of both garments specific chambers by way of tee or Y fittings and tubing assemblies. These tubing and fitting sub-assemblies require a large number of components and subsequent component connections which all lead to increases in component costs, labor required during assembly, and in potential points of fluid leakage/failure. Thus, a need exists for a multiple outlet manifold system that reduces the number of components, reduces required time to assemble the system, and provides more reliable sealing of the various fittings/connections. Specifically, the present invention is more robust in terms of surviving more cycles in use. During manufacture, the present invention is easier to assemble without error.

The multi-port multiple outlet manifold design described herein and shown in the figures provides numerous advantages over the design and manufacturing approaches described in prior art and used in commercially available production units. The prior art approach to porting of multi-ports into multiple outlets typically utilizes numerous T or Y connectors and tubing subassemblies that are costly, require lengthy assembly, and provide significant opportunities for failure of the system due to potential failure modes at each and every connection within the complex tubing and connector assemblies. The present invention utilizes less expensive production modes, simpler assembly therefore less expensive assembly labor costs (fewer components), smaller and lighter weight package form.

Another important design consideration regarding these pumps and garments are the design of the connection between them. The pumps need to be transportable and easy to setup prior to use. The setup of a compression device system involves two steps, namely connecting the garment(s) to the pump and the pump to an alternating current (“AC”) power source. The pumps are typically ac powered and therefore need to be attached to an AC outlet via an appropriate power cord. The other critical setup is combining the appropriate garment(s) to the pump. The garments vary in the number of chambers ranging from two to as many as twelve. The pumps typically have the ability to pressurize two garments at once for example a left and right limb. The pumps therefore require the user to assemble and disassemble the garment or garments onto the pump. The connection is a critical aspect of the intermittent compression pumping (ICP) system. The connection is a significant failure mode due to the repeated assembly and disassembly of the various garments. The quality of this critical design feature will impact the users' perceived quality, function and reliability of the IPC system.

Ideally, a “pump to garment” connection mechanism should resist shear forces and reduces or eliminates the possibility of wear or abuse after significant cyclical use; incorporate a simple quick connect design that can be utilized with minimal dexterity and low force; should only require single hand action; should be friendly to both left and right handed dominant users; should have physical features and visual icons on both the garment connections and pump connections that aid in usually identifying male and female components; should have no manual alignment of either connections sub-assembly required prior to mating of the connections.

Prior art pumps and connections do not achieve all of these objectives. Therefore, a need exists for an improved multi-port connection that achieves all of the objectives.

### SUMMARY

Broadly, described here is a multi-port connection and multi-port multiple outlet manifold that allows for the better quality, less expensive and quicker achievement of the functional requirements described within. In particular, described herein are improved connections and manifolds utilized in a multi-port and multiple outlet pump and compression garment system.

In one exemplary embodiment, the present invention comprises a quick release fluid tube connection apparatus, said connection apparatus comprising: an outer locking collar; an asymmetrical male connector core, said male core secured within said locking ring via an orientation ring adapted to fit around the male connector core; and a compression spring disposed within said locking collar to seal said core within said collar.

In another exemplary embodiment, the present invention comprises a manifold for use with an intermittent compression device garment, said manifold comprising: a plurality of outlet ports, where each of said outlet ports is fluidically connected to a chamber within a fluid fillable garments; and an inlet port fluidically connected to a fluid pump.

In yet another exemplary embodiment, the present invention comprises an intermittent pneumatic compression device system, said system comprising: a fluid pump, said pump electronically connected to a control apparatus and fluidically connected to a manifold inlet port, said manifold comprising: a plurality of outlet ports, where each of said outlet ports is fluidically connected to a chamber within a fluid fillable compression garments, wherein each of said compression garments comprises at least two fluid fillable chambers, where said compression garment chambers are fluidically connected to said outlets of said manifold such that said chambers can be selectively and individually filled with fluid by said pump.

### DRAWINGS

Embodiments or variations are now described by way of example with reference to the accompanying drawings. FIGS. 1 through 7 are in reference to the multi-port connection while FIGS. 8 through 15 are in reference to the multi-port multiple outlets manifold.

FIG. 1 shows an isometric view of a multi-port connection assembly.

FIG. 2 shows an exploded view of a multi-port connection assembly.

FIGS. 3a, 3b, and 3c show an isometric view, a side view, and an end view respectively of the male connector core component utilized within a multi-port connection assembly according the present invention.

FIGS. 4a, 4b, and 4c show an isometric view, a side view, and an end view respectively of the orientation ring component utilized within a multi-port connection assembly of the present invention.

FIGS. 5a, 5b, and 5c show an isometric view, a side view, and an end view respectively of the compression spring component utilized within a multi-port connection assembly according to the present invention.

FIGS. 6a, 6b, and 6c show an isometric view, a side view, and an end view, respectively, of the outer locking collar component utilized within a multi-port connection assembly of the present invention.

FIGS. 7a and 7b show an isometric view and an end view, respectively, of the assembly locking ring component utilized within a multi-port connection assembly of the present invention.

FIG. 8 shows an isometric view of the multi-port multiple outlet manifold of the present invention with female connector ports.

FIG. 9 shows an exploded view of the multi-port multiple outlet manifold of the present invention with female connector ports.

FIGS. 10a and 10b show a front view and a side view, respectively, of the multi-port multiple outlet manifold of the present invention with female connector ports.

FIGS. 11a, 11b, and 11c show an isometric view, a side view, and a front view, respectively, of the female connector port component of the present invention.

FIGS. 12a, 12b, and 12c show an isometric view, a front view, and a back view, respectively, of the front distribution plate component utilized within the multi-port multiple outlet manifold of the present invention.

FIGS. 13a and 13b show an isometric view and a front view, respectively, of a distribution plate utilized within the multi-port multiple outlet manifold of the present invention.

FIGS. 14a and 14b show an isometric view and a front view, respectively, of a manifold body component utilized within the multi-port multiple outlet manifold of the present invention.

FIGS. 15a and 15b show an isometric view and a front view, respectively, of a vent plate component utilized within the multi-port multiple outlet manifold of the present invention.

FIG. 16 shows an intermittent compression device system according to the present invention.

### DESCRIPTION

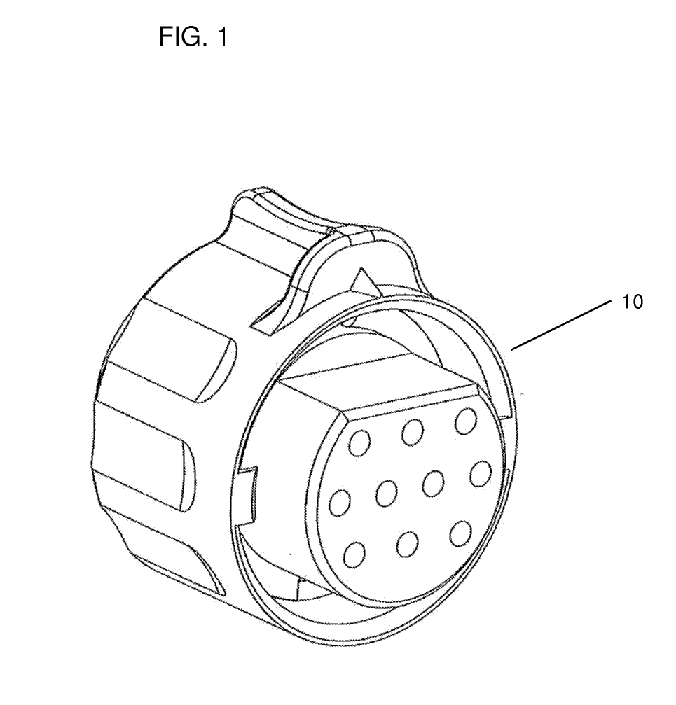

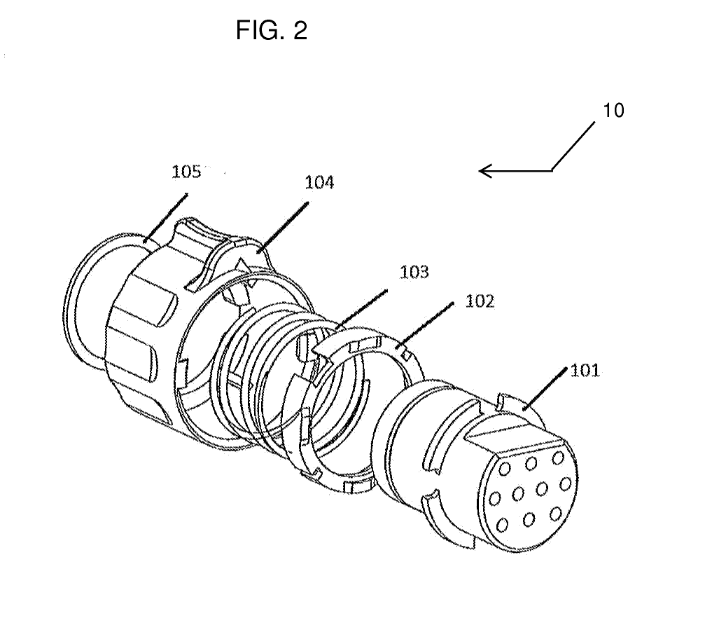

FIG. 1 shows an exemplary embodiment of a multi-port connection apparatus 10. As further illustrated in FIG. 2, an exploded view of the multi-port connection apparatus 10 from FIG. 1, apparatus 10 generally comprises a male connector core 101, an orientation ring 102, a compression spring 103, an outer locking collar 104, and an assembly locking ring 105.

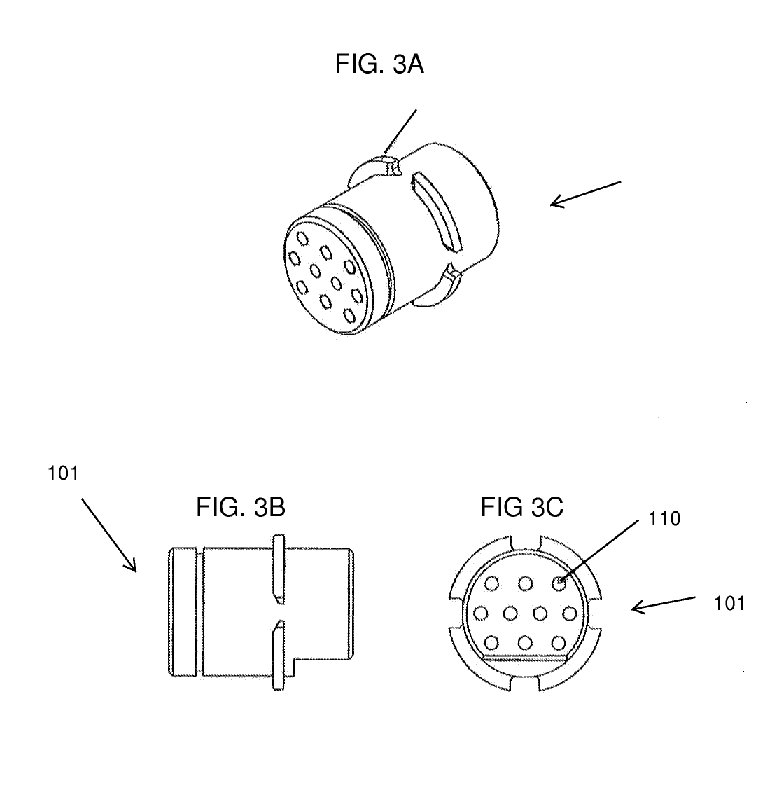

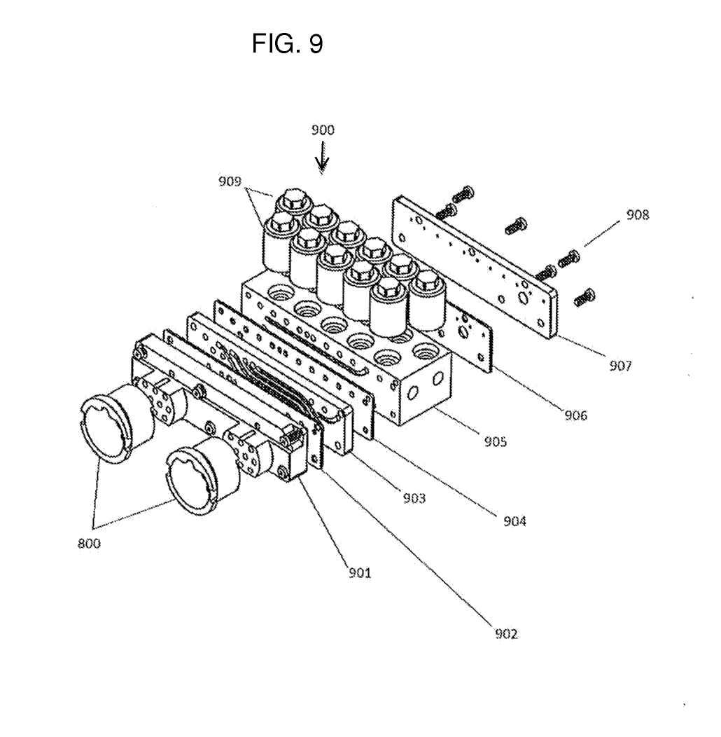

Referring next to FIGS. 3a, 3b, and 3c, there is shown, respectively, an isometric view, side view, and front view of male connector core 101. Male connector core 101 generally comprises a cylindrical shape having a first end and a second end. As best illustrated in FIG. 3b, the second end of male connector core 101 of multi-port connection apparatus 10 comprises a non-circular shape when male connector 101 is viewed along the longitudinal axis of male connector 101. In a preferred embodiment of the present invention, the second end of male connector 101 comprises a D-shaped geometry for quick alignment and mating with the female connector port 800 shown in FIG. 9.

Referring now to FIG. 3c, there is shown a front view of male connector core 101. As illustrated in FIG. 3c, male connector core 101 further comprises a plurality of fluid bores 110. In the preferred embodiment of the present invention, male connector 101 comprises a biologically inert thermoplastic or thermoset polymer such as ABS nylon, or polycarbonate. However, those of skill in the art will appreciate that connector core 101 may comprise other biologically inert materials, such as aluminium, stainless steel, cobalt chrome, or titanium if the design can be made to be suitably light weight for a particular application.

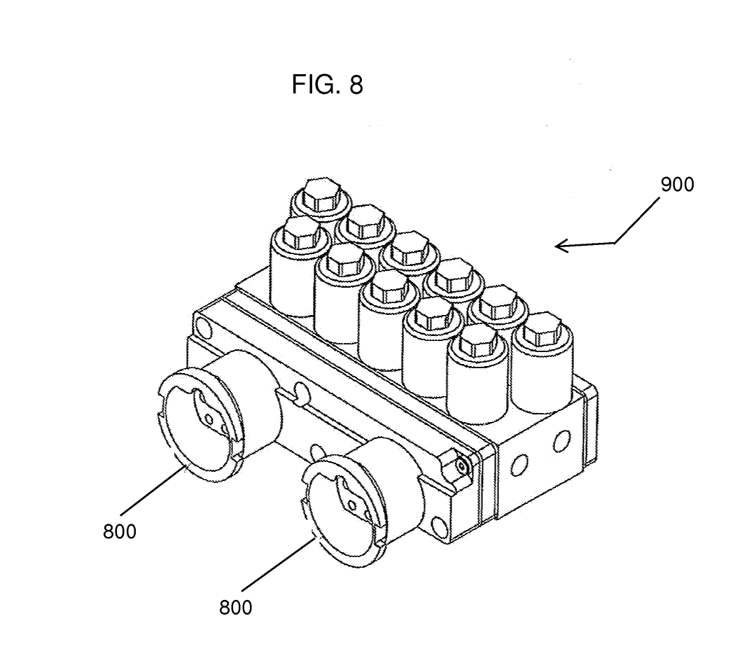

Referring still to FIGS. 3a, 3b, and 3c, male connector core 101 further comprises a plurality of peripheral flanges 120 that provide both an audible and tactile feedback to a user that male connector core 101 is properly positioned with mating orientation ring 102 and the peripheral tapered flanges of female connector port 800 shown in FIG. 8.

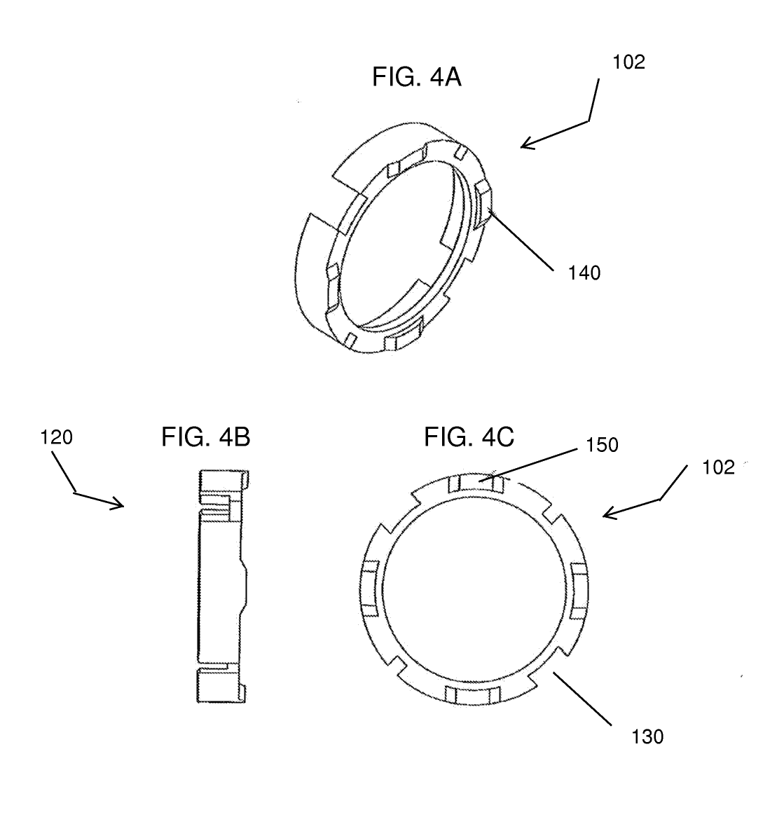

Referring now to FIGS. 4a, 4b, and 4c, there is shown, respectively, an isometric view, a side view, and a front view of orientation ring 102 of multi-port connection apparatus 10. Orientation ring 102 comprises various relief slots 130, raised protrusions 140 and anti-rotation grooves 150 for providing tactile and audible feedback to the user of the locking or unlocking of the outer locking collar 104. Orientation ring 102 preferably comprises a material selected from the group consisting of ABS, nylon, or polycarbonate.

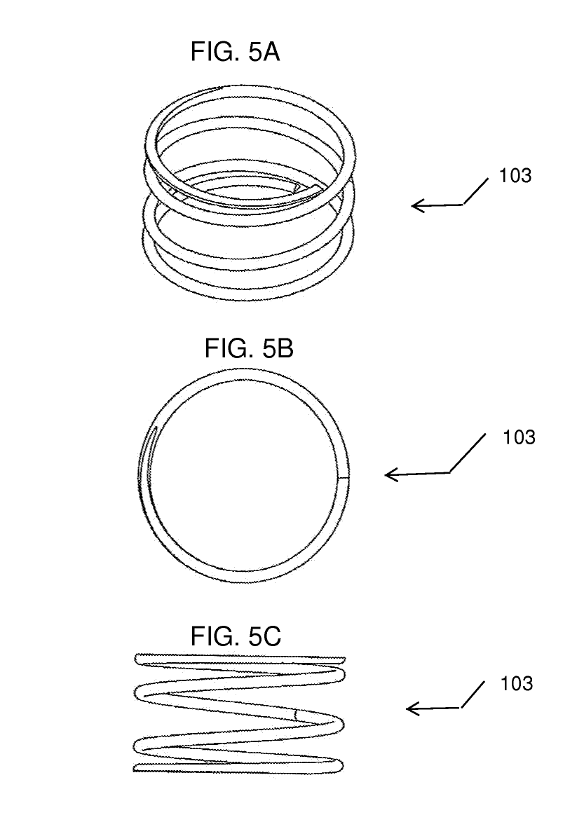

Referring now to FIGS. 5a, 5b, and 5c, there is shown, respectively, an isometric view, a top view, and a side view of compression spring 103 of multi-port connection apparatus 10. Spring 103 provides a face seal compressive force between male connection 101 and female connection 104 to ensure that no fluid leakage occurs between the same. Spring 103 preferably comprises a common, light weight, fluid resistant metal or other material.

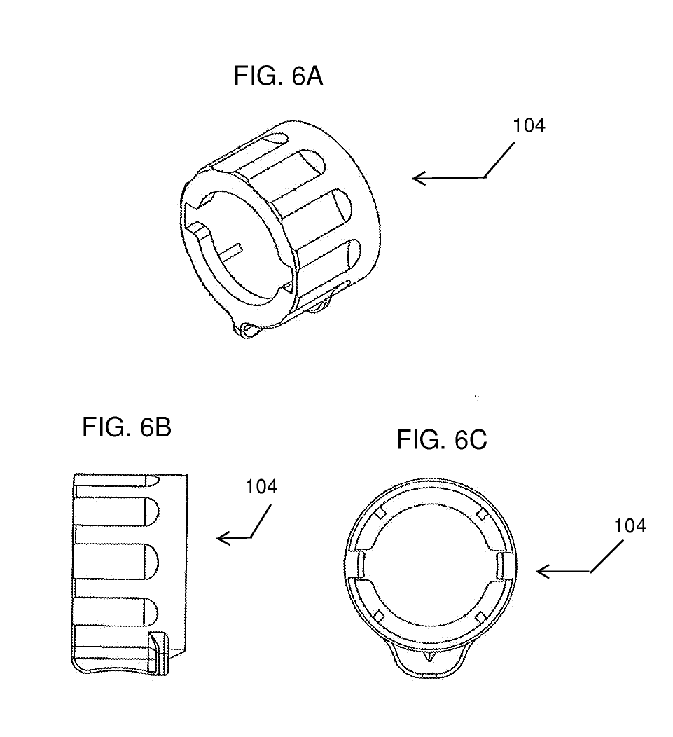

Referring next to FIGS. 6a, 6b, and 6c, there is shown, respectively, an isometric view, a side view, and a front view of outer locking collar 104 of multi-port connection apparatus 10. As best illustrated in FIG. 2, collar 104 is twisted in either a clockwise or counterclockwise direction relative to male connector 101 to the mating components via the provided locking tabs of the outer locking collar 104 with the peripheral tapered flanges of the female connector port 800 shown in FIG. 8.

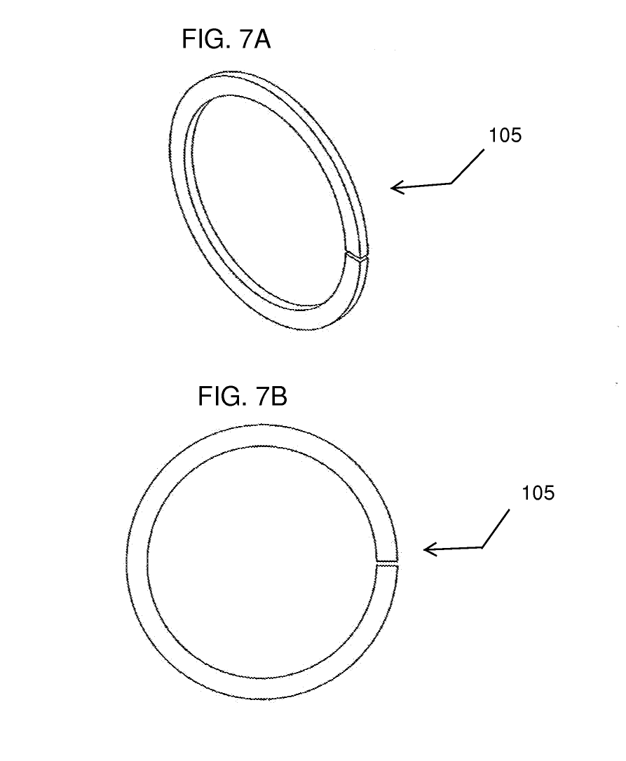

FIGS. 7a and 7b show assembly locking ring 105 of multi-port connection apparatus 10. Locking ring 105 is used to maintain a pre-load within the assembly shown in FIG. 2 thereby providing improved sealing of the face seals within apparatus 10.

Referring next to FIGS. 8 and 9, FIG. 8 shows an isometric view of an exemplary embodiment of a multi-port multiple outlet manifold 900 according to the present invention with two female connection ports 800. FIG. 9 shows an exploded, isometric view of the multi-port multiple outlet manifold 900 shown in FIG. 8.

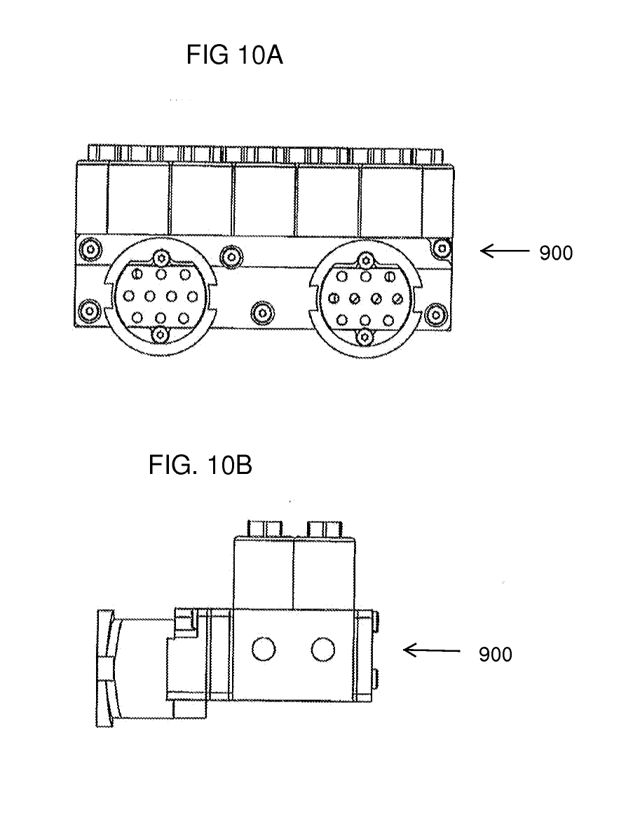

Referring again to FIG. 9, multi-port multiple outlet manifold 900 generally comprises front distribution plate 901, gasket 902, distribution plate 903, gasket 904, manifold body 905, vent gasket 906, vent plate 907, fasteners 908, and a set of controlling solenoids 909. As illustrated in FIG. 9, front distribution plate 901 abuts gasket 902. FIGS. 10a and 10b show, respectively, a front view and a side view of fully assembled multi-port outlet manifold 900.

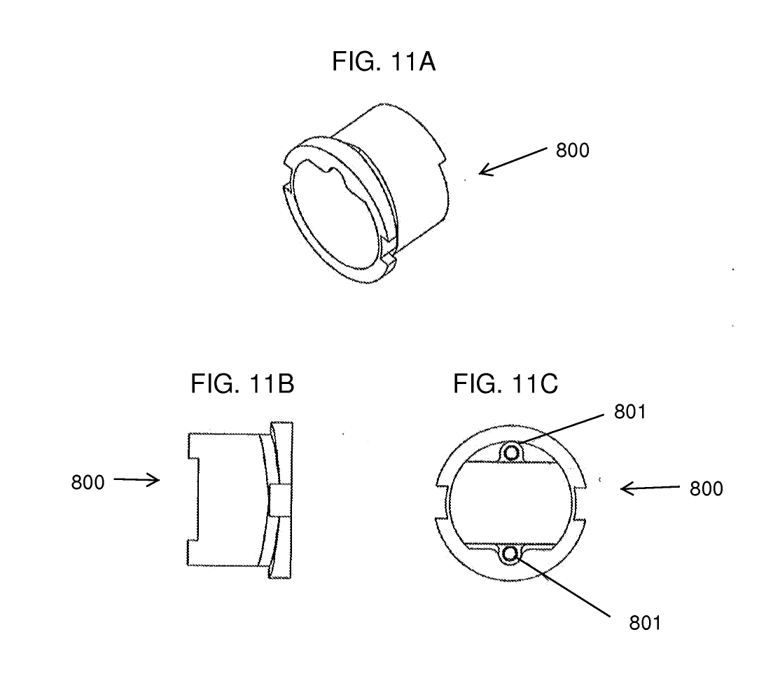

Referring next to FIGS. 11a, 11b, and 11c, there is shown, respectively, an isometric view, a side view, and a front view of female connector port 800 of the multi-port multiple outlet manifold 900 apparatus. As illustrated in FIG. 11a, female connector port 800 comprises an elongated shape having a central bore. Preferably, port 800 comprises a generally cylindrical shape and a flange on one side having a slightly larger diameter than the main body of port 800. Port 800 further comprises bores 801, as shown in FIG. 11c, to receive fasteners to affix port 800 to front distribution plate 901. Port 800 preferably comprises a material selected from the group consisting of ABS, nylon, or polycarbonate.

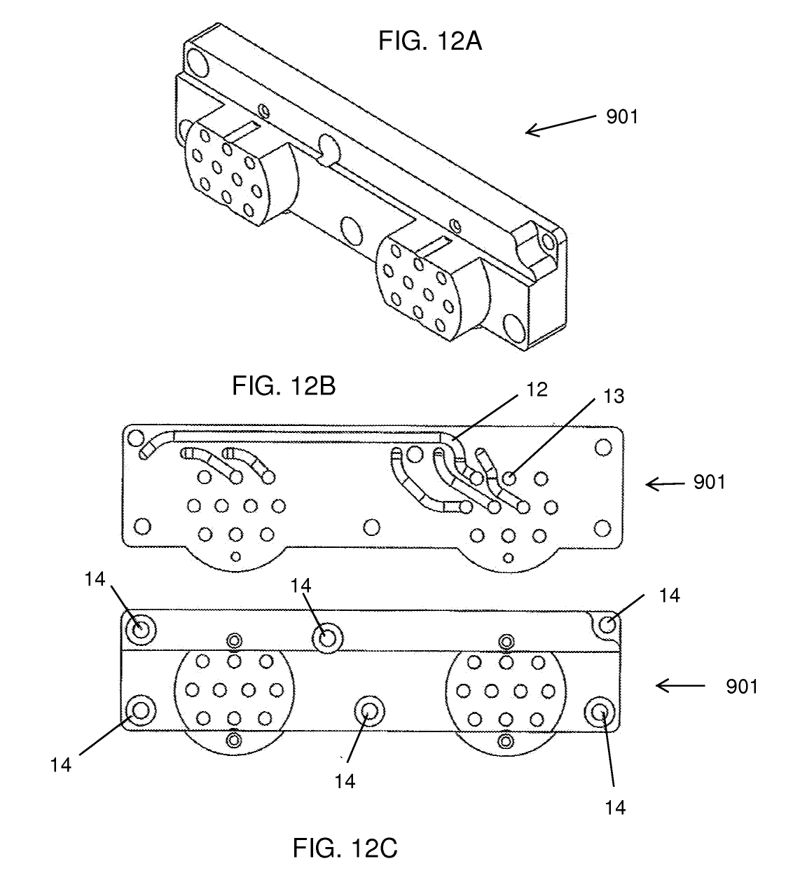

Referring now to FIGS. 12a, 12b, and 12c, there is shown, respectively, an isometric view, a rear view and a front view of front distribution plate 901 of multi-port multiple outlet manifold 900. Distribution plate 901 preferably comprises a material selected from the group consisting of ABS, nylon, or aluminum. Distribution plate 901 further comprises a plurality of fluid pathways 12 and bores 13 as illustrated in FIG. 12b. Additionally, distribution plate 901 comprises fastening bore 14 for accepting screws or bolt for affixing plate 901 to component 902 as illustrated in FIG. 9.

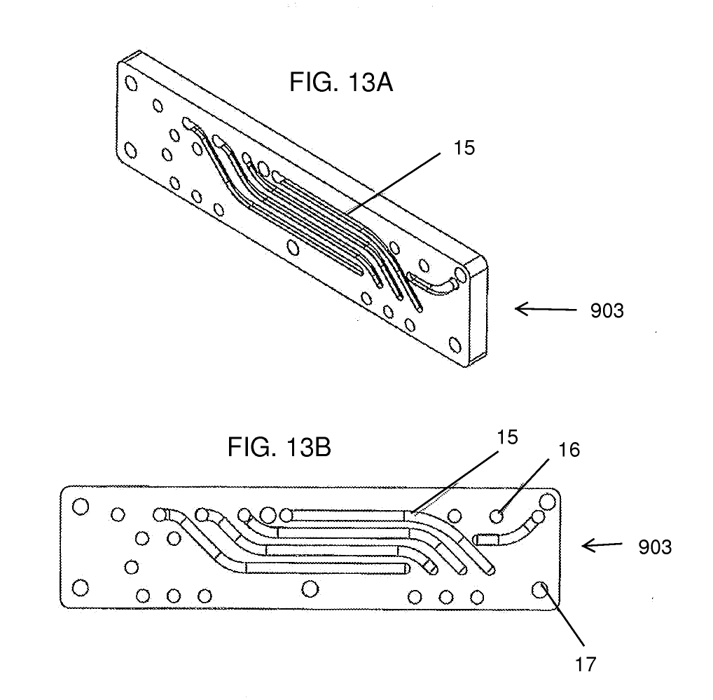

FIGS. 13a and 13b show an isometric view and a front view, respectively, of distribution plate 903. Distribution plate 903 preferably comprises a material selected from the group consisting of ABS, nylon, and aluminum. Distribution plate 903 further comprises a plurality of fluid pathways 15 and bores 16 as illustrated in FIG. 13b. Additionally, distribution plate 903 comprises fastening bores 17 for accepting screws or bolt for affixing plate 903 to components 902 and 904 as illustrated in FIG. 9.

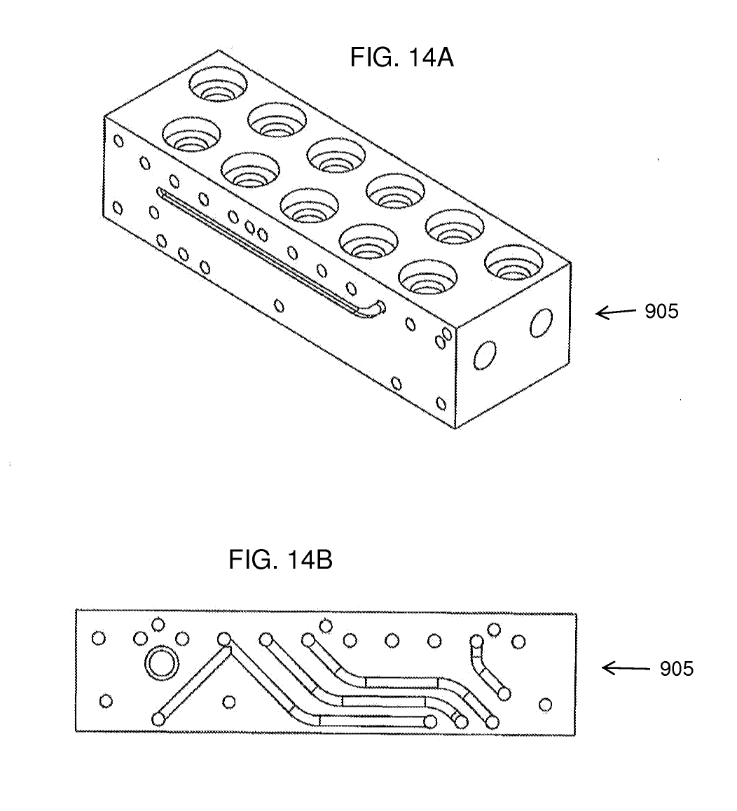

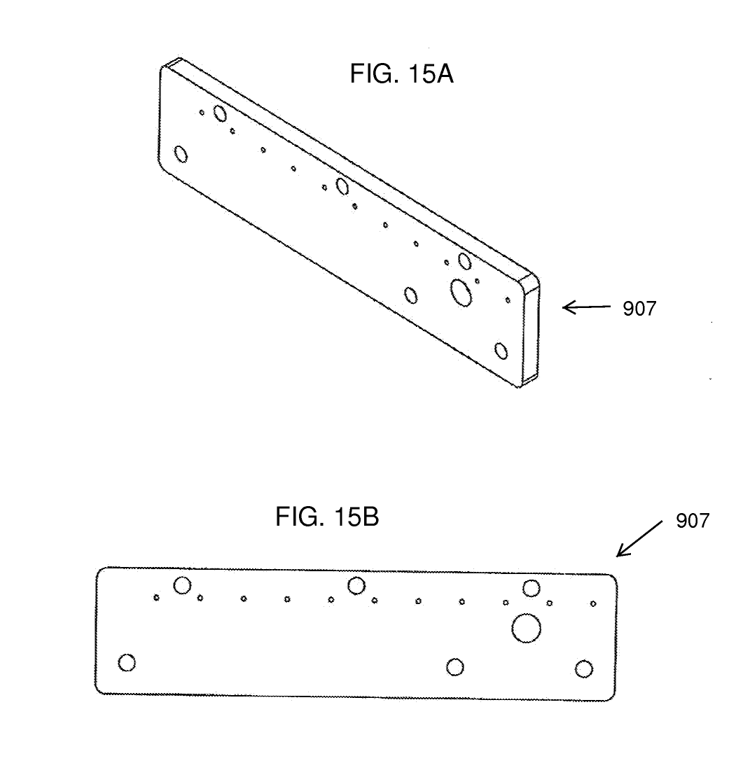

FIGS. 14a and 14b show an isometric view and a front view, respectively, of manifold body 905 utilized within the multi-port multiple outlet manifold of the present invention. Manifold body 905 comprises a generally cuboid shape with a plurality of fluid bores and fluid pathways as illustrated in FIGS. 14a and 14b. As illustrated in FIGS. 15a and 15b, the present invention may further comprise vent plate 907 affixed to the back of manifold body 905 as shown in FIG. 9.

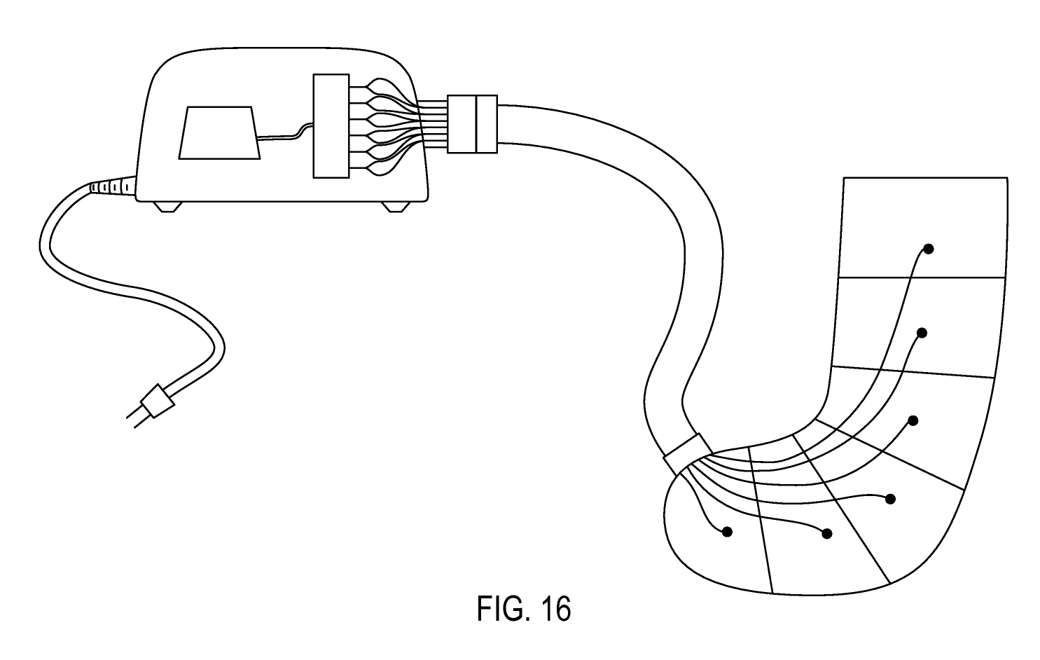

Referring now to FIG. 16, the present invention may further comprise at least one fluid pump fluidically connected to manifold 900 and at least one control device electronically connected to the fluid pump. As further illustrated in FIG. 16, the present invention may comprise a one or more fluid fillable garments fluidically connected to manifold 900 such that the pump can selectively fill various compartments within each garment.

1. A quick release fluid tube connection apparatus, said connection apparatus comprising: an outer locking collar; an asymmetrical male connector core, said male core secured within said locking ring via an orientation ring adapted to fit around the male connector core; and a compression spring disposed within said locking collar to seal said core within said collar.

2. A manifold for use with an intermittent compression device garment, said manifold comprising: a plurality of outlet ports, where each of said outlet ports is fluidically connected to a chamber within a fluid fillable garment; and an inlet port fluidically connected to a fluid pump.

3. An intermittent pneumatic compression device system, said system comprising: a fluid pump, said pump electronically connected to a control apparatus and fluidically connected to a manifold inlet port, said manifold comprising: a plurality of outlet ports, where each of said outlet ports is fluidically connected to a chamber within a fluid fillable compression garments, wherein each of said compression garments comprises at least two fluid fillable chambers, where said compression garment chambers are fluidically connected to said outlets of said manifold such that said chambers can be selectively and individually filled with fluid by said pump.
